(19) United States
(12) Patent Application Publication
(10) Pub. No.: US 2013/0071657 A1
(43) Pub. Date: Mar. 21, 2013

(54) REINFORCING SHEET FOR RESIN MOLDED PRODUCT, AND STRUCTURE AND METHOD FOR REINFORCING RESIN MOLDED PRODUCT

(71) Applicant: Takuya MASE, Osaka (JP)

(72) Inventor: Takuya MASE, Osaka (JP)

(73) Assignee: NITTO DENKO CORPORATION, Osaka (JP)

(21) Appl. No.: 13/614,716

(22) Filed: Sep. 13, 2012

(30) Foreign Application Priority Data
Sep. 15, 2011 (JP) 2011-201603

(51) Int. Cl. C09J 7/02; B32B 9/02; B32B 37/12; B32B 37/26; B32B 37/06

(52) U.S. Cl. 428/355 BL; 156/60; 156/322; 156/327; 428/343

(57) ABSTRACT

A reinforcing sheet for a resin molded product includes a constraining layer, and a reinforcing layer laminated on the constraining layer. The reinforcing layer is formed of an adhesive composition containing a polymer and a tackifier. The tackifier contains a high-softening-point tackifier having a softening point of not less than 120° C.

### CROSS-REFERENCE TO RELATED APPLICATION

The present application claims priority from Japanese Application No. 2011-201603 filed on Sep. 15, 2011, the content of which is herein incorporated by reference in its entirety.

### BACKGROUND OF THE INVENTION

1. Field of the Invention

The present invention relates to a reinforcing sheet for resin molded product, and a structure and method for reinforcing a resin molded product, and particularly to a reinforcing sheet for a resin molded product, and a structure and method for reinforcing a resin molded product using the same.

2. Description of the Related Art

Conventionally, resin plates or steel plates used in various industrial products have been each processed into a thin plate shape to reduce the weight of each of the products.

Therefore, in an attempt to reinforce the thin resin plate, it has been known to, e.g., provide ribs on the inner side of the resin plate.

Also, in an attempt to reinforce the thin steel plate, it has been known to, e.g., provide a steel-plate reinforcing sheet on the inner side of the steel plate.

For example, it is proposed that, after a steel-plate reinforcing sheet including a constraining layer, and a reinforcing layer made of a foam composition is stuck to the vehicle-body steel plate of an automobile, the reinforcing layer is foamed and cured using heat at a high temperature (in a range of, e.g., 160 to 200° C.) during electrodeposition coating to reinforce the vehicle-body steel plate of the automobile (see, e.g., Japanese Unexamined Patent No. 2005-41210).

### SUMMARY OF THE INVENTION

However, the ribs are typically molded integrally with a resin plate so that, during the molding thereof, sinks occur in the surfaces of the portions of the resin plate which are reinforced by the ribs. This results in the problem of impaired outer appearance of the resin plate.

When reinforcement is effected using the steel-plate reinforcing sheet described in Japanese Unexamined Patent No. 2005-41210, the reinforcing layer of the steel-plate reinforcing sheet needs to be heated to 160 to 200° C. to be cured. However, if such a steel-plate reinforcing sheet is stuck to the resin plate and heated to 160 to 200° C., a problem arises that the resin plate is degraded or melted.

In addition, after being stuck to a resin plate or steel plate, the reinforcing sheet including the steel-plate reinforcing sheet may be placed together therewith in an atmosphere at a high temperature (of a level at which the resin plate is not melted) and, in that case also, the reinforcing sheet including the steel-plate reinforcing sheet is desired to retain an excellent reinforcing ability.

An object of the present invention is to provide a reinforcing sheet for a resin molded product and a structure and method for reinforcing a resin molded product with which it is possible to maintain a light weight and excellent outer appearance, easily reinforce a resin molded product while preventing the resin molded product from being degraded or melted, and also maintain an excellent reinforcing ability in an atmosphere at a high temperature of a level at which the resin molded product is not melted.

A reinforcing sheet for a resin molded product of the present invention includes a constraining layer, and a reinforcing layer laminated on the constraining layer, wherein the reinforcing layer is formed of an adhesive composition containing a polymer and a tackifier, and the tackifier contains a high-softening-point tackifier having a softening point of not less than 120° C.

In the reinforcing sheet for a resin molded product of the present invention, it is preferable that the high-softening-point tackifier is a terpene phenol resin and/or a hydrogenated terpene resin.

In the reinforcing sheet for a resin molded product of the present invention, it is preferable that a blending ratio of the tackifier based on 100 parts by mass of the polymer is in a range of 40 to 200 parts by mass.

In the reinforcing sheet for a resin molded product of the present invention, it is preferable that the tackifier further contains a low-softening-point tackifier having a softening point of less than 120° C., and the low-softening-point tackifier is an alicyclic saturated hydrocarbon resin.

In the reinforcing sheet for a resin molded product of the present invention, it is preferable that the polymer contains a hydrogenated product of a polymer of a monomer containing a conjugated diene.

Alternatively, the reinforcing sheet for a resin molded product of the present invention includes a constraining layer, and a reinforcing layer laminated on the constraining layer, wherein the reinforcing layer is formed of an adhesive composition containing a polymer, the polymer contains a hydrogenated product of a polymer of a monomer containing a conjugated diene and a copolymerizable monomer which can be copolymerized with the conjugated diene, and a content ratio of the copolymerizable monomer in the monomer is not less than 35 mass %.

In a structure for reinforcing a resin molded product of the present invention, the reinforcing sheet for a resin molded product described above is stuck to a resin molded product, and then heated to a temperature of not less than 80° C. to be brought into tight adhesive contact with the resin molded product to reinforce the resin molded product.

In the structure for reinforcing a resin molded product of the present invention, it is preferable that the reinforcing sheet for a resin molded product is heated in advance to a temperature of not less than 80° C. and then stuck to the resin molded product.

A method for reinforcing a resin molded product of the present invention includes the steps of sticking the reinforcing sheet for a resin molded product described above to a resin molded product, and heating the reinforcing sheet for a resin molded product and/or the resin molded product to a temperature of not less than 80° C. to bring the reinforcing sheet for a resin molded product into tight adhesive contact with the resin molded product and thereby reinforce the resin molded product.

In the method for reinforcing a resin molded product of the present invention, it is preferable that, in the step of sticking the reinforcing sheet for a resin molded product to the resin molded product, the reinforcing sheet for a resin molded product is heated in advance to a temperature of not less than 80° C. and then stuck to the resin molded product.

According to the structure and method for reinforcing a resin molded product of the present invention using the reinforcing sheet for a resin molded product of the present invention, the reinforcing layer of the reinforcing sheet for a resin molded product is stuck to the resin molded product to allow tight adhesive contact to be provided between the constraining layer and the resin molded product.

In the reinforcing sheet for a resin molded product of the present invention, the reinforcing layer is formed of the adhesive composition containing the polymer and the tackifier, and the tackifier contains the high-softening-point tackifier having a softening point of not less than 120° C. Therefore, even in an atmosphere at a high temperature of a level at which the resin molded product is not melted, the high-softening-point tackifier is not softened to allow the reinforcing layer to retain its shape. As a result, it is possible to improve the rigidity of the reinforcing sheet for a resin molded product in the high-temperature atmosphere.

Alternatively, in the reinforcing sheet for a resin molded product of the present invention, the reinforcing layer is formed of the adhesive composition containing the polymer, the polymer contains the hydrogenated product of the polymer of the monomer containing the conjugated diene and the copolymerizable monomer which can be copolymerized with the conjugated diene, and the content ratio of the copolymerizable monomer in the monomer is not less than 35 mass %. Therefore, even in an atmosphere at a high temperature of a level at which the resin molded product is not melted, the hydrogenated product is not softened to allow the reinforcing layer to retain its shape. As a result, it is possible to improve the rigidity of the reinforcing sheet for a resin molded product in the high-temperature atmosphere.

Accordingly, it is possible to reliably reinforce a resin molded product using such a reinforcing sheet for a resin molded product.

In particular, even in an atmosphere at a high temperature of a level at which the resin molded product is not melted, it is possible to maintain a light weight, excellent outer appearance, and the excellent reinforcing ability of the structure for reinforcing a resin molded product, while preventing the resin molded product from being degraded or melted.

Moreover, by sticking the reinforcing sheet for a resin molded product only to the portion of the resin molded product desired to be reinforced, only the portion can be easily reinforced.

In addition, a simple configuration including the constraining layer and the reinforcing layer allows the resin molded product to be reinforced, while achieving reductions in the thickness and weight thereof.

### BRIEF DESCRIPTION OF THE DRAWINGS

FIG. 1 is an illustrative view showing an embodiment of a method for reinforcing a resin molded product of the present invention, in which a reinforcing sheet for a resin molded product of the present invention is stuck to a resin molded product to reinforce it,

(a) showing the step of preparing the reinforcing sheet for a resin molded product and stripping a release film therefrom, and

(b) showing the step of sticking the reinforcing sheet for resin molded product to the resin molded product.

### DETAILED DESCRIPTION OF THE INVENTION

A reinforcing sheet for a resin molded product of the present invention (first aspect of the invention) includes a constraining layer, and a reinforcing layer laminated on the constraining layer.

The constraining layer is provided so as to impart tenacity to the reinforcing layer after stuck and heated. The constraining layer is in the form of a sheet, lightweight and thin, and preferably formed of a material which can be brought into tight adhesive contact with the reinforcing layer to be integrated therewith. Examples of such a material include glass cloth, resin-impregnated glass cloth, nonwoven fabric, metal foil, carbon fiber, and polyester film.

The glass cloth is cloth made of glass fiber, and known glass cloth can be used.

The resin-impregnated glass cloth is the foregoing glass cloth impregnated with a synthetic resin such as a thermosetting resin or a thermoplastic resin, and known resin-impregnated glass cloth can be used. Examples of the thermosetting resin include an epoxy resin, a urethane resin, a melamine resin, and a phenol resin. Examples of the thermoplastic resin include a vinyl acetate resin, an ethylene-vinyl acetate copolymer (EVA), a vinyl chloride resin, and an EVA-vinyl chloride resin copolymer. Each of the thermosetting resins and thermoplastic resins mentioned above can be used alone or in combination.

Examples of the nonwoven fabric include those formed of fibers such as wood fiber (such as wood pulp), cellulose fiber (e.g., regenerated cellulose fiber such as rayon, semisynthetic cellulose fiber such as acetate, natural cellulose fiber such as linen or cotton, or blended yarn thereof), polyester fiber, polyvinyl alcohol (PVA) fiber, polyamide fiber, polyolefin fiber, polyurethane fiber, and cellulose fiber (cellulose fiber derived from linen or a material other than linen).

Examples of the metal foil include known metal foil such as aluminum foil or steel foil.

The carbon fiber is cloth made of fiber containing carbon as a main component, and known carbon fiber can be used.

Examples of the polyester film include a polyethylene terephthalate (PET) film, a polyethylene naphthalate (PEN) film, and a polybutylene terephthalate (PBT) film. Preferably, the PET film is used.

Among these examples of the constraining layer, the resin-impregnated glass cloth is used preferably if consideration is given to adhesion, strength, and cost.

The constraining layer has a thickness in a range of, e.g., 0.05 to 2.0 mm, or preferably 0.1 to 1.0 mm.

The reinforcing layer is formed by molding an adhesive composition into a sheet shape.

The adhesive composition is thermoplastic. Specifically, the adhesive composition exhibits thermal adhesiveness (thermally pressure-sensitive adherence) through heating.

The adhesive composition contains a polymer and a tackifier.

Examples of the polymer include a hydrogenated product (hydride) of a polymer of a monomer including a conjugated diene.

Preferably, the monomer contains the conjugated diene as an essential component, and contains a copolymerizable monomer which can be copolymerized with the conjugated diene as an optional component.

Examples of the conjugated diene include 1,3-butadiene, isoprene(2-methyl-1,3-butadiene), and chloroprene(2-chloro-1,3-butadiene).

The copolymerizable monomer has at least one double bond, and examples thereof include an aliphatic vinyl monomer such as ethylene, propylene, and isobutylene(2-methylpropene); an aromatic vinyl monomer such as styrene, chlorostyrene, and vinyltoluene; and a cyano group-containing vinyl monomer such as (meth)acrylonitrile.

Such a copolymerizable monomer can be used alone or in a combination of two or more kinds.

Among these copolymerizable monomers, the aromatic vinyl monomer is used preferably.

Specific examples of the polymer include a block or random copolymer of the conjugated diene and the copolymerizable monomer and, preferably, the block copolymer is used. Specifically, a styrene-butadiene-styrene block copolymer (SBS), a styrene-isoprene-styrene block copolymer (SIS), or the like can be used.

Note that the blending ratio of the copolymerizable monomer based on 100 parts by mass of the conjugated diene is in a range of, e.g., 5 to 80 parts by mass, or preferably 15 to 50 parts by mass.

That is, the blending ratio between the copolymerizable monomer (preferably an aromatic vinyl monomer, or more preferably styrene) and the conjugated diene (preferably 1,3-butadiene) based on mass is in a range of, e.g., 50 mass % or less/50 mass % or more (mass ratio between the copolymerizable monomer and the conjugated diene), or preferably 40 mass % or less/60 mass % or more, and normally 10 mass % or more/90 mass % or less.

In the hydrogenated product of the polymer mentioned above, the unsaturated bond (double bond portion) derived from the conjugated diene is completely hydrogenated or partially hydrogenated, or preferably completely hydrogenated. Specific examples of the hydrogenated product include a styrene-ethylene-butylene-styrene copolymer (SEBS, or more specifically a SEBS block copolymer).

Due to the hydrogenation of the polymer described above, the hydrogenated product does not substantially contain an unsaturated bond, and is therefore less likely to be thermally degraded in a high-temperature atmosphere. This allows an improvement in the heat resistance of the reinforcing layer.

The hydrogenated product has a melt flow rate (MFR) in a range of, e.g., not more than 10 g/10 min, or preferably not more than 5 g/10 min, and normally not less than 0.1 g/10 min at a temperature of 190° C. and with a mass of 2.16 kg.

The hydrogenated product has a melt flow rate (MFR) in a range of, e.g., not more than 50 g/10 min, or preferably not more than 20 g/10 min, and normally not less than 0.1 g/10 min at a temperature of 200° C. and with a mass of 5 kg.

The hydrogenated product has a melt flow rate (MFR) in a range of, e.g., not more than 50 g/10 min, or preferably not more than 20 g/10 min, and normally not less than 0.1 g/10 min at a temperature of 230° C. and with a mass of 2.16 kg.

Such a hydrogenated product can be used alone or in a combination of two or more kinds.

Among these examples of the hydrogenated product, SEBS is used preferably.

As the polymer, a combination of, e.g., a polymer (including a polymer before being hydrogenated in the production of the hydrogenated product) such as SBS or SIS and the hydrogenated product can also be used.

The tackifier contains a high-softening-point tackifier.

The high-softening-point tackifier is contained in the tackifier so as to improve the adhesion between the reinforcing layer and each of the resin molded product and the constraining layer or improve a reinforcing property when the resin molded product is reinforced in an atmosphere at a high temperature of a level at which the resin molded product is not melted. The high-softening-point tackifier has a softening point of not less than 120° C. Examples of the high-softening-point tackifier include a rosin resin having a softening point of not less than 120° C., a terpene resin (including a terpene-phenol copolymer and a hydrogenated terpene resin) having a softening point of not less than 120° C., a coumarone-indene resin having a softening point of not less than 120° C., an alicyclic saturated hydrocarbon resin having a softening point of not less than 120° C., and a petroleum resin (e.g., a hydrocarbon petroleum resin such as an aliphatic/aromatic copolymer petroleum resin or an aromatic petroleum resin) having a softening point of not less than 120° C.

When the softening point of the high-softening-point tackifier is less than the foregoing ranges, it is impossible to improve the reinforcing property when the resin molded product is reinforced in an atmosphere at a high temperature of a level at which the resin molded product is not melted.

The softening point of the high-softening-point tackifier is preferably in a range of not less than 130° C., more preferably not less than 140° C., particularly preferably not less than 150° C., and also, e.g., not more than 200° C.

Note that the softening point of the high-softening-point tackifier is measured by a ring and ball method.

The weight-average molecular weight of the high-softening-point tackifier is in a range of, e.g., 100 to 10000, or preferably 500 to 5000.

Note that the weight-average molecular weight is measured by a gel permeation chromatography (GPC) method using a GPC apparatus (HLC-8120 GPC available from Tosoh Corporation), and calculated in terms of equivalent standard polystyrene.

Such a high-softening-point tackifier may be used alone or in a combination of two or more kinds.

The blending ratio of the high-softening-point tackifier based on 100 parts by mass of the tackifier is in a range of, e.g., 20 to 100 parts by mass, or preferably 25 to 100 parts by mass.

When the blending ratio of the high-softening-point tackifier is less than the foregoing ranges, it may be impossible to achieve a sufficient reinforcing property when the resin molded resin is reinforced in an atmosphere at a high temperature of a level at which the resin molded product is not melted. When the blending ratio of the high-softening-point tackifier exceeds the foregoing ranges, it may be impossible to sufficiently improve the adhesion between the reinforcing layer and each of the resin molded product and the constraining layer.

As necessary, the tackifier contains a low-softening-point tackifier.

The low-softening-point tackifier is contained in the tackifier so as to improve the reinforcing property at a high temperature and also improve an adhesive force. The low -softening-point tackifier has a softening point of less than 120° C. Examples of the low-softening-point tackifier include a rosin resin having a softening point of less than 120° C., a terpene resin (including a terpene-phenol copolymer and a hydrogenated terpene resin) having a softening point of less than 120° C., a coumarone-indene resin having a softening point of less than 120° C., an alicyclic saturated hydrocarbon resin having a softening point of less than 120° C., and a petroleum resin (e.g., a hydrocarbon petroleum resin such as an aliphatic/aromatic copolymer petroleum resin or an aromatic petroleum resin) having a softening point of less than 120° C.

As the low-softening-point tackifier, the alicyclic saturated hydrocarbon resin is used preferably in terms of compatibility with the hydrogenated product.

The softening point of the low-softening-point tackifier is preferably in a range of not more than 110° C., and also, e.g., not less than 50° C.

Note that the softening point of the low-softening-point tackifier is measured by a ring and ball method.

Such a low-softening-point tackifier may be used alone or in a combination of two or more kinds.

The blending ratio of the low-softening-point tackifier to the tackifier is in a range of, e.g., 20 to 80 mass %, or preferably 25 to 75 mass %. Also, the blending ratio of the low-softening-point tackifier based on 100 parts by mass of the high-softening-point tackifier is in a range of, e.g., 10 to 300 parts by mass, or preferably 30 to 250 parts by mass.

When the blending ratio of the low-softening-point tackifier is less than the foregoing ranges, it may be impossible to sufficiently improve the adhesion between the reinforcing layer and each of the resin molded product and the constraining layer in an atmosphere at a high temperature of a level at which the resin molded product is not melted. When the blending ratio of the low-softening-point tackifier exceeds the foregoing ranges, the reinforcing layer may be brittle.

The blending ratio of the tackifier based on 100 parts by mass of the polymer is in a range of, e.g., 40 to 200 parts by mass, or preferably 50 to 170 parts by mass.

When the blending ratio of the tackifier is less than the foregoing ranges, it may be impossible to sufficiently improve the adhesion between the reinforcing layer and each of the resin molded product and the constraining layer or sufficiently improve the reinforcing property when the resin molded product is reinforced.

On the other hand, when the blending ratio of the tackifier exceeds the foregoing ranges, the reinforcing layer may be brittle.

To the adhesive composition, in addition to the foregoing components, additives such as a filler, an oxidation inhibitor, a softener (such as, e.g., naphthene oil or paraffin oil), a thixotropic agent (such as, e.g., montmorillonite), a lubricant (such as, e.g., a stearic acid), a pigment, an antiscorch agent, a stabilizer, an antioxidant, an ultraviolet absorber, an antifungal agent, and a fire retardant can also be added at an appropriate ratio.

The filler includes a colorant. Examples of the filler include magnesium oxide, calcium carbonate (such as, e.g., heavy calcium carbonate, light calcium carbonate, or Hakuenka®), magnesium silicate (such as, e.g., talc), mica, clay, mica powder, bentonite (such as, e.g., organic bentonite), silica, alumina, aluminum hydroxide, aluminum silicate, titanium oxide, carbon black (such as, e.g., insulating carbon black or acetylene black), aluminum powder, and glass balloon. These fillers may be used alone or in a combination of two or more kinds.

As the filler, calcium carbonate or carbon black is used preferably.

Examples of the oxidation inhibitor include an amine-ketone compound, an aromatic secondary amine compound, a phenol compound (such as, e.g., pentaerythritol tetrakis[3-(3,5-di-tert-butyl-4-hydroxyphenyl)propionate]), a benzimidazole compound (such as, e.g., 2-mercaptobenzimidazole), a thiourea compound, and a phosphite compound. These oxidation inhibitors can be used alone or in a combination of two or more kinds. Preferably, the phenol compound or benzimidazole compound is used.

The ratio of the additive to be added based on 100 parts by mass of the hydrogenated product is particularly in a range of, e.g., 1 to 200 parts by mass when the additive is the filler and, e.g., 0.1 to 5 parts by mass when the additive is the oxidation inhibitor.

The adhesive composition can be prepared by blending the individual components described above at the blending ratio described above. To further form the reinforcing layer and laminate the reinforcing layer on the constraining layer, a direct formation method can be used in which the individual components described above are dissolved or dispersed at the foregoing blending ratio in a known solvent (e.g., an organic solvent such as toluene) to prepare a solution or dispersion liquid, and then the obtained solution or dispersion liquid is applied on the surface of the constraining layer and then dried.

Alternatively, a transfer method can also be used in which the obtained solution or dispersion liquid is applied on the surface of a release film described later and then dried to form the reinforcing layer, and then the reinforcing layer is transferred to the surface of the constraining layer.

To prepare the adhesive composition to form the reinforcing layer and laminate the reinforcing layer on the constraining layer, another direct formation method can also be used in which the individual components described above (except for the solvent described above and water) are directly kneaded using, e.g., a mixing roll, a pressure kneader, an extruder, or the like to prepare a kneaded material, which is then molded into a sheet shape by, e.g., calendering, extrusion molding, press molding, or the like to form the reinforcing layer, which is then laminated on the surface of the constraining layer. Specifically, the kneaded material is disposed between the constraining layer and the release film (described later) to be sandwiched therebetween, which are then extended by, e.g., press molding into a sheet shape. Alternatively, another transfer method can also be used in which the formed reinforcing layer is laminated on the surface of the release film and then transferred to the surface of the constraining layer.

The reinforcing layer thus formed has a thickness in a range of, e.g., 0.02 to 3.0 mm, or preferably 0.03 to 1.3 mm.

The reinforcing sheet for resin molded product thus obtained has a thickness in a range of, e.g., 0.25 to 5.0 mm, or preferably 0.4 to 2.3 mm.

When the thickness of the reinforcing sheet for resin molded product exceeds the ranges described above, it may be difficult to achieve a reduction in the weight of the reinforcing sheet for resin molded product or the manufacturing cost thereof may be increased. When the thickness of the reinforcing sheet for resin molded product is less than the foregoing ranges, it may be impossible to sufficiently improve the reinforcing property.

Note that, in the obtained reinforcing sheet for resin molded product, the release film (separator)stuck to the top surface of the reinforcing layer (surface thereof opposite to the back surface thereof on which the constraining layer is stuck) can also be left as necessary for a period until the reinforcing sheet for resin molded product is actually used.

Examples of the release film include known release films such as synthetic resin films such as a polyethylene film, a polypropylene film, and a PET film.

After the reinforcing sheet for resin molded product (the reinforcing layer thereof) is stuck to a polypropylene plate having a thickness of 2.0 mm and heated at 80° C. for 10 minutes, the reinforcing sheet for resin molded product has a bending strength at a displacement of 1 mm at 90° C. which is in a range of, e.g., 0.8 to 5.0 N, preferably 1.0 to 4.0 N, or more preferably 1.2 to 3.0 N.

Specifically, to measure the bending strength of the reinforcing sheet for resin molded product stuck to the polypropylene plate at a displacement of 1 mm at 90° C., the reinforcing layer is first brought into contact with the polypropylene plate having a thickness of 2.0 mm to stick the reinforcing sheet for resin molded product to the polypropylene plate, which are then put into a drier set at 80° C. (temperature for achieving tight adhesive contact) for 10 minutes and brought into tight adhesive contact with each other to provide a laminate plate.

Thereafter, the laminate plate retrieved from the drier is trimmed into a piece measuring 150 mm long and 25 mm wide to obtain a test specimen.

Thereafter, in a universal testing machine provided with a thermostatic bath set at 90° C. (measurement temperature), the test specimen is placed in the thermostatic bath, and the bending strength of the test specimen at a displacement of 1 mm at 90° C. is measured by a three point bending test in which the distance between supporting points is set to 100 mm and the center (lengthwise center and widthwise center) of the test specimen is pressed from the polypropylene plate side with an indenter having a diameter of 10 mm at a speed of 50 mm/min.

The measured bending strength is defined to be the bending strength of the reinforcing sheet for resin molded product adhesively bonded to the polypropylene plate at a displacement of 1 mm at 90° C.

In the description given above, the bending strength is calculated on the condition that the measurement temperature is 90° C. and the displacement is 1 mm but, even at a room temperature (25° C.), and a displacement (other than 1 mm) each described later, the bending strength is calculated by performing the same processing.

Note that the foregoing bending strength at a displacement of 1 mm is measured as a bending strength (strength) at the time when the indenter is displaced by 1 mm after the initiation of pressing.

If the bending strength at a displacement of 1 mm at 90° C. is within the foregoing range, in an atmosphere at a high temperature of a level at which the resin molded product is not melted, the resin molded product can be sufficiently reinforced.

After the reinforcing sheet for resin molded product (the reinforcing layer thereof) is stuck to the polypropylene plate having a thickness of 2.0 mm and heated at 80° C. for 10 minutes, the reinforcing sheet for resin molded product has a bending strength at a displacement of 2 mm at 90° C. which is in a range of, e.g., 1.2 to 8.0 N, or preferably 2.0 to 6.0 N.

After the reinforcing sheet for resin molded product (the reinforcing layer thereof) is stuck to the polypropylene plate having a thickness of 2.0 mm and heated at 80° C. for 10 minutes, the reinforcing sheet for resin molded product has a maximum bending strength at 90° C. which is in a range of, e.g., 6.0 to 40.0 N, or preferably 7.5 to 30.0 N.

Note that the maximum bending strength is obtained as a maximum bending strength (strength) between the time of initiation of pressing and the time of fracture of the test specimen.

If the bending strength at 90° C. mentioned above is within the foregoing ranges, the resin molded product can be sufficiently reinforced in an atmosphere at a high temperature of a level at which the resin molded product is not melted.

After the reinforcing sheet for resin molded product (the reinforcing layer thereof) is stuck to the polypropylene plate having a thickness of 2.0 mm and heated at 80° C. for 10 minutes, the reinforcing sheet for resin molded product has a bending strength at a displacement of 1 mm at a room temperature (25° C.) which is in a range of, e.g., 6.0 to 20.0 N, preferably 7.0 to 16.0 N, or more preferably 8.0 to 15.0 N.

After the reinforcing sheet for resin molded product (the reinforcing layer thereof) is stuck to the polypropylene plate having a thickness of 2.0 mm and heated at 80° C. for 10 minutes, the reinforcing sheet for resin molded product has a bending strength at a displacement of 2 mm at a room temperature (25° C.) which is in a range of, e.g., 11.0 to 40.0 N, preferably 12.0 to 40.0 N, or more preferably 14.0 to 36.0 N.

After the reinforcing sheet for resin molded product (the reinforcing layer thereof) is stuck to the polypropylene plate having a thickness of 2.0 mm and heated at 80° C. for 10 minutes, the reinforcing sheet for resin molded product has a maximum bending strength at a room temperature (25° C.) which is in a range of, e.g., 65.0 to 150.0 N, or preferably 80.0 to 140.0 N.

If the bending strength at 25° C. mentioned above is within the foregoing ranges, the resin molded product can be sufficiently reinforced in an atmosphere at a high temperature of a level at which the resin molded product is not melted.

After the reinforcing layer is stuck to the polypropylene plate at a room temperature and heated at 80° C. for 10 minutes, the reinforcing sheet for resin molded product has an adhesive force (post-heating adhesive force) to the propylene plate which is measured by a 90° peel test at a peeling speed of 300 mm/min to be, e.g., not less than 2 N/25 mm, preferably not less than 3 N/25 mm, or more preferably not less than 4 N/25 mm, and also, e.g., not more than 50N/25 mm.

If the post-heating adhesive force of the reinforcing sheet for resin molded product is within the ranges shown above, the reinforcing layer shows adherence through heating. Therefore, the reinforcing sheet for resin molded product can be reliably adhesively bonded to the resin molded product in an atmosphere at a high temperature of a level at which the resin molded product is not melted.

The adhesive force described above is measured according to JIS Z0237 (2009).

Note that each of the adhesive forces of the reinforcing sheet for resin molded product is substantially the same as the adhesive force of the corresponding reinforcing layer.

The reinforcing sheet for resin molded product of the present invention is used to reinforce a resin molded product.

The resin molded product is not particularly limited as long as the resin molded product needs reinforcement. For example, a resin molded product used for various industrial products can be used.

Examples of a resin for forming the resin molded product include a low-polarity resin such as polyolefin.

Examples of polyolefin include polypropylene and polyethylene. Preferably, polypropylene is used.

Specific examples of such a resin molded product include the bumper of an automobile and the instrument panel thereof.

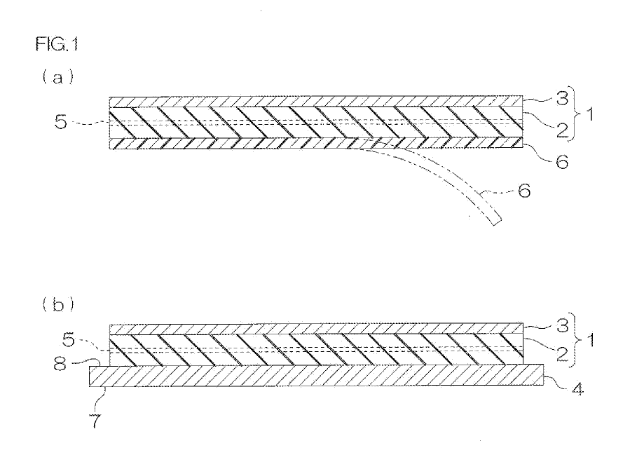

FIG. 1 is an illustrative view showing an embodiment of a method for reinforcing a resin molded product of the present invention, in which a reinforcing sheet for a resin molded product of the present invention is stuck to a resin molded product to reinforce it, (a) showing the step of preparing the reinforcing sheet for a resin molded product and stripping a release film therefrom, and (b) showing the step of sticking the reinforcing sheet for a resin molded product to the resin molded product.

Next, referring to FIG. 1, a description is given to an embodiment of a structure and method for reinforcing a resin molded product of the present invention in which the reinforcing sheet for resin molded product of the present invention is stuck to the resin molded product to reinforce it.

As shown in FIG. 1(a), in a reinforcing sheet for resin molded product 1, a reinforcing layer 2 is laminated on a constraining layer 3, and a release film 6 is stuck as necessary to the top surface of the reinforcing layer 2 (surface thereof opposite to the back surface thereof on which the constraining layer 3 is laminated).

As shown in FIG. 1(b), the resin molded product 4 is to be used in the various industrial products described above, and is formed in, e.g., a plate shape. More specifically, the resin molded product 4 is formed to include an outer surface 7 which is recognizable in an outer appearance and an inner surface 8 which is not recognizable in the outer appearance.

To stick the reinforcing sheet for resin molded product 1 to the resin molded product 4, as shown by the phantom line in FIG. 1(a), the release film 6 is stripped first from the surface of the reinforcing layer 2. Then, as shown in FIG. 1(b), the surface of the reinforcing layer 2 is brought into contact with the inner surface 8 of the resin molded product 4, and pressure-bonded thereto as necessary. In the pressure bonding of the reinforcing sheet for resin molded product 1, pressing is performed under a pressure in a range of, e.g., about 0.15 to 10 MPa.

Further, as necessary, heating (thermocompression) can also be performed simultaneously with pressing. That is, the reinforcing sheet for resin molded product 1 is heated in advance, and then the heated reinforcing sheet for resin molded product 1 is stuck to the resin molded product 4.

Conditions for the thermocompression include a temperature which is in a range of, e.g., not less than 80 C°, preferably not less than 90 C°, or more preferably not less than 100 C°, and normally not more than the heat resistance temperature of the resin molded product 4. Specifically, the temperature is in a range of, e.g., not more than 130 C°, preferably 30 to 120 C°, or more preferably 80 to 110 C°.

Thereafter, the resin molded product 4 to which the reinforcing sheet for resin molded product 1 is stuck is preferably heated.

The heating temperature is in a range of, e.g., not less than 80 C°, preferably not less than 90 C°, or more preferably not less than 100 C°, and normally not more than the heat resistance temperature of the resin molded product 4. Specifically, the temperature is in a range of, e.g., not more than 130 C°, preferably 30 to 120 C°, or more preferably 80 to 110 C°. The heating time is in a range of, e.g., 0.5 to 20 minutes, or preferably 1 to 10 minutes.

When the heating temperature and the heating time are less than the ranges shown above, it may be impossible to achieve sufficiently tight adhesive contact between the resin molded product 4 and the constraining layer 3 or sufficiently improve the reinforcing property when the resin molded product 4 is reinforced. When the heating temperature and the heating time exceed the ranges shown above, the resin molded product 4 may be degraded or melted.

The heating of the resin molded product 4 described above is performed by putting the resin molded product 4 to which the reinforcing sheet for resin molded product 1 is stuck into a drying oven in the drying step of the manufacturing of the resin molded product 4.

Alternatively, when the manufacturing of the resin molded product 4 does not include the drying step, a partially heating device such as a heat gun is used instead of putting the resin molded product 4 into the drying oven described above to heat only the reinforcing sheet for resin molded product 1.

Otherwise, it is also possible to use the heating device described above and heat only the resin molded product 4 or each of the reinforcing sheet for resin molded product 1 and the resin molded product 4. Note that, when only the resin molded product 4 is heated, heat from the heating device is transferred (thermally conducted) to the reinforcing sheet for resin molded product 1 via the resin molded product 4.

Then, the reinforcing sheet for resin molded product 1 is stuck to the resin molded product 4. Thereafter, the reinforcing sheet for resin molded product 1 and/or the resin molded product 4 is further heated as necessary such that the reinforcing sheet for resin molded product 1 is brought into tight adhesive contact with the resin molded product 4. In this manner, the structure for reinforcing the resin molded product 4 is formed in which the resin molded product 4 is reinforced by the reinforcing sheet for resin molded product 1.

According to the structure and method for reinforcing the resin molded product 4, by adhesively bonding the reinforcing layer 2 of the reinforcing sheet for resin molded product 1 to the resin molded product 4, the constraining layer 3 and the resin molded product 4 can be brought into tight adhesive contact with each other.

In addition, in the reinforcing sheet for resin molded product 1 of the present invention, the reinforcing layer 2 is formed of the adhesive composition containing the polymer and the tackifier, and the tackifier contains a high-softening-point tackifier having a softening point of not less than 120° C. Therefore, even in an atmosphere at a high temperature of a level at which the resin molded product 4 is not melted, the high-softening-point tackifier is not softened to allow the reinforcing layer 2 to retain its shape. As a result, it is possible to improve the rigidity of the reinforcing sheet for resin molded product 1 in the high-temperature atmosphere.

Accordingly, it is possible to reliably reinforce the resin molded product 4 using the reinforcing sheet for resin molded product 1.

In particular, even in an atmosphere at a high temperature of a level at which the resin molded product 4 is not melted, it is possible to maintain a light weight and excellent outer appearance, and also maintain the excellent reinforcing ability of the structure for reinforcing the resin molded product 4, while preventing the resin molded product 4 from being degraded or melted.

In other words, it is possible to maintain a light weight and excellent outer appearance in an atmosphere at a high temperature (specifically in the range of 60 to 90° C.) in which the resin molded product 4 is not melted, but is prone to thermal deformation, and maintain the excellent reinforcing ability of the structure for reinforcing the resin molded product 4, while preventing the resin molded product 4 from being degraded or melted.

Moreover, by sticking the reinforcing sheet for resin molded product 1 only to the portion of the resin molded product 4 desired to be reinforced, only the portion can be easily reinforced.

In addition, a simple configuration including the constraining layer 3 and the reinforcing layer 2 allows the resin molded product 4 to be reinforced while achieving reductions in the thickness and weight thereof.

In the description given above, the reinforcing layer 2 is formed only of one sheet made of an adhesive composition. However, as shown by, e.g., the broken line in FIG. 1, nonwoven fabric 5 may also be allowed to intervene in the reinforcing layer 2 at a intermediate point in the thickness direction thereof.

As the nonwoven fabric 5, the same nonwoven fabric as shown above can be used. The nonwoven fabric 5 has a thickness in a range of, e.g., 0.01 to 0.3 mm.

To manufacture the reinforcing sheet for resin molded product 1 in accordance with, e.g., a direct formation method, a first reinforcing layer is laminated on the constraining layer 3, the nonwoven fabric 5 is laminated on the top surface of the first reinforcing layer (surface thereof opposite to the back surface thereof on which the constraining layer 3 is laminated), and then a second reinforcing layer is laminated on the top surface of the nonwoven fabric 5 (surface thereof opposite to the back surface thereof on which the first reinforcing layer is laminated).

In accordance with a transfer method, the nonwoven fabric 5 is sandwiched between the first reinforcing layer and the second reinforcing layer from the both top surface and back surface sides of the nonwoven fabric 5. Specifically, the first reinforcing layer and the second reinforcing layer are formed first on the respective surfaces of two release films 6, and then the first reinforcing layer is transferred to the back surface of the nonwoven fabric 5, while the second reinforcing layer is transferred to the top surface of the nonwoven fabric 5.

By interposing the nonwoven fabric 5, the reinforcing layer 2 can be easily formed thick in accordance with the strength of the resin molded product 4 desired to be reinforced.

Next, a description is given to a reinforcing sheet for resin molded product as a second aspect of the invention.

Note that, when the layers, materials, the blending ratios, methods, and physical properties (evaluation) of the reinforcing sheet for resin molded product as the second aspect of the invention are the same as those of the reinforcing sheet for resin molded product as the first aspect of the invention described above, a detailed description thereof is omitted.

An adhesive composition contains a polymer.

The polymer contains a hydrogenated product (hydride) of a polymer of a monomer containing a conjugated diene and a copolymerizable monomer which can be copolymerized with the conjugated diene.

As the copolymerizable monomer, an aromatic vinyl monomer is preferably used, or more preferably, styrene is used.

The content ratio of the copolymerizable monomer in the monomer is in a range of not less than 35 mass %.

When the content ratio of the copolymerizable monomer is less than the foregoing range, the reinforcing property when the resin molded product is reinforced cannot be sufficiently improved.

The content ratio of the copolymerizable monomer is preferably in a range of not less than 40 mass %, and, e.g., not more than 70 mass %, or preferably not more than 60 mass %.

That is, the blending ratio between the copolymerizable monomer (preferably styrene) and the conjugated diene (preferably 1,3-butadiene) based on mass is 35 mass % or more/65 mass % or less, preferably 40 mass % or more/60 mass % or less, e.g., 70 mass % or less/30 mass % or more, or preferably 60 mass % or less/40 mass % or more.

In other words, the blending ratio of the copolymerizable monomer based on 100 parts by mass of the conjugated diene is in a range of, e.g., not less than 50 parts by mass, preferably 55 to 200 parts by mass, or more preferably 60 to 150 parts by mass.

Preferably, the adhesive composition further contains a tackifier so as to improve the adhesion between a reinforcing layer and each of a resin molded product and a constraining layer or improve the reinforcing property when the resin molded product is reinforced.

Examples of the tackifier include the high-softening-point tackifier and the low-softening-point tackifier each described above.

Among these tackifiers, the low-softening-point tackifier is used preferably, or more preferably, an alicyclic saturated hydrocarbon resin having a softening point of less than 120° C. is used in terms of the compatibility with the hydrogenated product.

In the reinforcing sheet for resin molded product of the second aspect of the invention, the reinforcing layer is formed of the adhesive composition containing the polymer, the polymer contains the hydrogenated product of the polymer of the monomer containing the conjugated diene and the copolymerizable monomer which can be copolymerized with the conjugated diene, and the content ratio of the copolymerizable monomer in the monomer is not less than 35 mass %. Therefore, even in an atmosphere at a high temperature (specifically in the range of 60 to 90° C.) of a level at which the resin molded product is not melted, the hydrogenated product is not softened to allow the reinforcing layer to retain its shape. As a result, it is possible to improve the rigidity of the reinforcing sheet for resin molded product in the high-temperature atmosphere.

Next, a description is given to a reinforcing sheet for resin molded product as a third aspect of the invention.

The reinforcing sheet for resin molded product as the third aspect of the invention is included in each of the first and second aspects of the invention. In the reinforcing sheet for resin molded product as the third aspect of the invention, a reinforcing layer is formed of a tackifier composition containing the tackifier of the first aspect of the invention and the polymer of the second aspect of the invention.

That is, in the reinforcing layer, the tackifier contains a high-softening-point tackifier having a softening point of not less than 120° C., the polymer contains a hydrogenated product of a polymer of a monomer containing a conjugated diene and a copolymerizable monomer which can be copolymerized with the conjugated diene, and the content ratio of the copolymerizable monomer in the monomer is not less than 35 mass %.

The reinforcing sheet for resin molded product of the third aspect of the invention achieves the same function and effect as achieved by the reinforcing sheet for resin molded product of the first aspect of the invention and the reinforcing sheet for resin molded product of the second aspect of the invention.

### EXAMPLES

While in the following, the present invention is described more specifically with reference to Examples and Comparative Example, the present invention is by no means limited thereto.

### Examples 1-10

In accordance with the blending formulation shown in Table 1, the individual components were blended on a part by mass basis, and kneaded with a mixing roll heated in advance to 120° C. to prepare kneaded materials of thermoplastic adhesive compositions.

Then, each of the prepared kneaded materials of the adhesive compositions was sandwiched between resin-impregnated glass cloth (constraining layer) impregnated with an epoxy resin and having a thickness of 0.18 mm and a release film, and extended into a sheet shape by press molding at 120° C. to produce a reinforcing sheet for resin molded product having a thickness of 0.8 mm (see FIG. 1(a)). Note that the thickness of a reinforcing layer was 0.62 mm.

### Comparative Example 1

In accordance with the blending formulation shown in Table 1, the individual components were blended on a part by mass basis, and processed in the same manner as in Examples 1 to 10 to produce a reinforcing sheet for resin molded product having a thickness of 0.78 mm (see FIG. 1(a)). Note that the thickness of a reinforcing layer was 0.60 mm.

TABLE 1

| | | | | | Content | | | | | | | | | | | | |
|---|---|---|---|---|---|---|---|---|---|---|---|---|---|---|---|---|---|
| | | | | | Ratio of | Soften- | | | | | | | | | | | |
| | | | | | Styrene | ing | | | | | | | | | | | Comp. |
| | | | | | (Mass | Point | Ex. | Ex. | Ex. | Ex. | Ex. | Ex. | Ex. | Ex. | Ex. | Ex. | Ex. |
| | | | | | %) | (° C.) | 1 | 2 | 3 | 4 | 5 | 6 | 7 | 8 | 9 | 10 | 1 |
| Adhe- | Poly- | Hydro- | SEBS | Tuftec | 30 | — | 100 | 100 | 100 | 100 | 100 | — | — | — | — | — | — |
| sive | mer | genated | | H1041 | | | | | | | | | | | | | |
| Compo- | | Product | | Tuftec | 67 | | — | — | — | — | — | 100 | — | 50 | 100 | 100 | — |
| sition | | of | | H1043 | | | | | | | | | | | | | |
| (Rein- | | Polymer | | Tuftec | 42 | | — | — | — | — | — | — | 100 | 50 | — | — | — |
| forcing | | | | H1051 | | | | | | | | | | | | | |
| Layer) | | Polymer | SBS | Asaprene | 30 | | — | — | — | — | — | — | — | — | — | — | 50 |
| | | | | T432 | | | | | | | | | | | | | |
| | | | | Tufprene | 40 | | — | — | — | — | — | — | — | — | — | — | 50 |
| | | | | A | | | | | | | | | | | | | |

| | | | | | | | | | | | | | | | |
|---|---|---|---|---|---|---|---|---|---|---|---|---|---|---|---|
| Tacki- | Terpene Phenol | YS | — | 160 | 100 | — | 30 | — | 50 | — | — | — | 30 | — | — |
| fier | Resin | Polyster | | | | | | | | | | | | | |
| | | T160 | | | | | | | | | | | | | |
| | Hydrogenated | Arkon | | 150 | — | 100 | — | 30 | 50 | — | — | — | — | 30 | — |
| | Terpene Resin | P150 | | | | | | | | | | | | | |
| | Alicyclic | Arkon | | 100 | — | — | 70 | 70 | — | 70 | 70 | 70 | 70 | 70 | — |
| | Saturated | P100 | | | | | | | | | | | | | |
| | Hydrocarbon | Arkon | | 100 | — | — | — | — | — | 30 | 30 | 30 | — | — | — |
| | Resin | P100 | | | | | | | | | | | | | |
| | Hydrocarbon | Petrotack | | 88 | — | — | — | — | — | — | — | — | — | — | 100 |
| | Petroleum Resin | 90HM | | | | | | | | | | | | | |

| Filler | Heavy Calcium Carbonate | 100 | 100 | 100 | 100 | 100 | 100 | 100 | 100 | 100 | 100 | 100 |
|---|---|---|---|---|---|---|---|---|---|---|---|---|
| | Asahi Carbon #50 | 1 | 1 | 1 | 1 | 1 | 1 | 1 | 1 | 1 | 1 | 3 |
| Oxidation Inhabitor | Irganox 1010 | 2 | 2 | 2 | 2 | 2 | 2 | 2 | 2 | 2 | 2 | — |

| | | | | | | | | | | | |
|---|---|---|---|---|---|---|---|---|---|---|---|
| Nocrac MB | 1 | 1 | 1 | 1 | 1 | 1 | 1 | 1 | 1 | 1 | 1 |

Note that the values of the individual components of each of the adhesive compositions (reinforcing layers) in Table 1 show the numbers of parts of the blended components.

The details of the individual components shown in Table 1 are shown below.

Tuftec H1041 is a styrene-ethylene-butylene-styrene block copolymer available from Asahi Kasei Chemicals Corporation and having a styrene/ethylene-butadiene ratio of 30 mass %/70 mass %, an MFR (190° C., 2.16 kg) of 0.3 g/10 min, an MFR (200° C., 5 kg)) of 3.5 g/10 min, and an MFR (230° C., 2.16 kg) of 5.0 g/10 min.

Tuftec H1043 is a styrene-ethylene-butylene-styrene block copolymer available from Asahi Kasei Chemicals Corporation and having a styrene/ethylene-butadiene ratio of 67 mass %/33 mass %, an MFR (200° C., 5 kg) of 5.0 g/10 min, and an MFR (230° C., 2.16 kg) of 2.0 g/10 min.

Tuftec H1051 is a styrene-ethylene-butylene-styrene block copolymer available from Asahi Kasei Chemicals Corporation and having a styrene/ethylene-butadiene ratio of 42 mass %/58 mass %, an MFR (200° C., 5 kg) of 0.5 g/10 min, and an MFR (230° C., 2.16 kg) of 0.8 g/10 min.

Asaprene T432 (trade name) is a styrene-butadiene-styrene block copolymer available from Asahi Kasei Chemicals Corporation and having a styrene/butadiene ratio of 30 mass %/70 mass %.

Tufprene A (trade name) is a styrene-butadiene-styrene block copolymer available from Asahi Kasei Chemicals Corporation and having a styrene/butadiene ratio of 40 mass %/60% mass %.

YS Polyster T160 is a terpene-phenol copolymer available from Yasuhara Chemical Co., Ltd. and having a softening point (measured by a ring and ball method) of 160° C., a weight-average molecular weight of 1200 (measured by a GPC method based on calculation in terms of equivalent PS), and a glass transition point (measured by a DSC method) of 103° C.

Arkon P150 is a hydrogenated terpene resin available from Arakawa Chemical Industries and having a softening point (measured by a ring and ball method) of 150° C., a weight-average molecular weight of 750 (measured by a GPC method based on calculation in terms of equivalent PS), and a glass transition point (measured by a DSC method) of 93° C.

Arkon P100 is an alicyclic saturated hydrocarbon resin available from Arakawa Chemical Industries and having a softening point (measured by a ring and ball method) of 100° C.

Arkon M100 is an alicyclic saturated hydrocarbon resin available from Arakawa Chemical Industries and having a softening point (measured by a ring and ball method) of 100° C.

Petrotack 90HM is a hydrocarbon petroleum resin available from Tosoh Corporation and having a softening point (measured by a ring and ball method) of 88° C.

Heavy calcium carbonate is available from Maruo Calcium, Co., Ltd.

Asahi Carbon #50 is carbon black available from Asahi Carbon Co., Ltd.

Irganox 1010 is pentaerythritol tetrakis[3-(3,5-di-tert-butyl-4-hydroxyphenyl)propionate] available from BASF Japan Ltd.

Nocrac MB is 2-mercaptobenzimidazole available from Ouchi Shinko Chemical Industrial Co., Ltd.

(Evaluation)

As Examples 1 to 10 and Comparative Example 1, the obtained bending strengths and adhesive forces were evaluated as follows.

The results thereof are shown in Table 2.

(1) Bending Strength of Reinforcing Sheet for Resin Molded Product

The reinforcing sheets for resin molded product of Examples 1 to 10 and Comparative Example 1 were stuck to polypropylene plates each having a thickness of 2.0 mm such that reinforcing layers came in contact with the polypropylene plates. The reinforcing sheets for resin molded product and the polypropylene plates were then put into a drier set at 80° C. (temperature for achieving tight adhesive contact) for 10 minutes and brought into tight adhesive contact with each other to provide laminate plates. Then, the laminate plates retrieved from the drier were each trimmed into pieces each measuring 150 mm long and 25 mm wide to obtain test specimens.

The obtained test specimens were placed in the respective thermostatic baths of a universal testing machine (available from Minebea Co., Ltd.) set at the measurement temperatures (25° C. and 90° C.) shown in Table 2 and, by a three point bending test, a bending strength at a displacement of 1 mm, a bending strength at a displacement of 2 mm, and a maximum bending strength were measured for each of the test specimens.

Note that, in the three point bending test, in the universal testing machine (available from Minebea Co., Ltd.), the distance between supporting points was set to 100 mm and the center (lengthwise center and widthwise center) of each of the test specimens was pressed from the polypropylene plate side with an indenter having a diameter of 10 mm at a speed of 50 mm/min.

(2) Adhesive Force After Heating (Post-Heating Adhesive Force) of Reinforcing Layer

Only for the reinforcing layer formed in each of Examples 1 to 10 and Comparative Example 1, by a 90° peel test according to JIS Z0237 (2009) at a peeling speed of 300 mm/min, the post-heating adhesive force to the polypropylene plate was measured.

First, only the reinforcing layer of each of Examples 1 to 10 and Comparative Example 1 was stuck to the polypropylene plate at a room temperature (25° C.). Then, after the reinforcing layer and the polypropylene plate were heated at 80° C. for 10 minutes, the adhesive force (post-heating adhesive force) of the reinforcing layer to the polypropylene plate was measured.

TABLE 2

| | | | Exs. and Com. Ex | | | | | | | | | | |
|---|---|---|---|---|---|---|---|---|---|---|---|---|---|
| | Measurement | | | | | | | | | | | | Comp. |
| | Temperature | Displacement | Ex. 1 | Ex. 2 | Ex. 3 | Ex. 4 | Ex. 5 | Ex. 6 | Ex. 7 | Ex. 8 | Ex. 9 | Ex. 10 | Ex. 1 |
| Bending | 25° C. | Displacement of | 12.1 | 8.2 | 9.1 | 6.2 | 10.9 | 13.3 | 13.4 | 13.1 | 11.0 | 15.8 | 5.9 |
| Strength | | 1 mm | | | | | | | | | | | |
| [N] | | Displacement of | 23.6 | 14.3 | 16.5 | 11.6 | 21.5 | 25.6 | 25.3 | 24.6 | 19.7 | 30.1 | 11.8 |
| | | 2 mm | | | | | | | | | | | |
| | | Maximum | 116.1 | 70.5 | 82.1 | 69.1 | 102.9 | 125.1 | 122.9 | 117.3 | 125.1 | 133.1 | 62.7 |
| | 90° C. | Displacement of | 2.3 | 1.5 | 1.2 | 1.3 | 1.8 | 2.1 | 2.1 | 2.3 | 2.7 | 3.0 | 0.6 |
| | | 1 mm | | | | | | | | | | | |
| | | Displacement of | 4.1 | 2.9 | 2.1 | 2.3 | 3.2 | 4.0 | 3.8 | 4.2 | 4.9 | 5.4 | 1.1 |
| | | 2 mm | | | | | | | | | | | |
| | | Maximum | 14.4 | 12.4 | 7.9 | 8.6 | 11.9 | 19.8 | 15.2 | 18.1 | 25.5 | 27.7 | 5.1 |

| | | | | | | | | | | | | |
|---|---|---|---|---|---|---|---|---|---|---|---|---|
| Adhesive Force | Post-Heating | 2.7 | 17.8 | 33.7 | 25.8 | 14.8 | 6.9 | 24.8 | 20.1 | 8.0 | 3.2 | 21.2 |
| [N/25 mm] | | | | | | | | | | | | |

While the illustrative embodiments of the present invention are provided in the above description, such is for illustrative purpose only and it is not to be construed limitative. Modification and variation of the present invention which will be obvious to those skilled in the art is to be covered by the following claims.

What is claimed is:

1. A reinforcing sheet for a resin molded product, comprising:
a constraining layer; and
a reinforcing layer laminated on the constraining layer, wherein
the reinforcing layer is formed of an adhesive composition containing a polymer and a tackifier, and
the tackifier contains a high-softening-point tackifier having a softening point of not less than 120° C.

2. A reinforcing sheet for a resin molded product according to claim 1, wherein the high-softening-point tackifier is a terpene phenol resin and/or a hydrogenated terpene resin.

3. A reinforcing sheet for a resin molded product according to claim 1, wherein a blending ratio of the tackifier based on 100 parts by mass of the polymer is in a range of 40 to 200 parts by mass.

4. A reinforcing sheet for a resin molded product according to claim 1, wherein
the tackifier further contains a low-softening-point tackifier having a softening point of less than 120° C., and
the low-softening-point tackifier is an alicyclic saturated hydrocarbon resin.

5. A reinforcing sheet for a resin molded product according to claim 1, wherein the polymer contains a hydrogenated product of a polymer of a monomer containing a conjugated diene.

6. A reinforcing sheet for a resin molded product, comprising:
a constraining layer; and
a reinforcing layer laminated on the constraining layer, wherein
the reinforcing layer is formed of an adhesive composition containing a polymer,
the polymer contains a hydrogenated product of a polymer of a monomer containing a conjugated diene and a copolymerizable monomer which can be copolymerized with the conjugated diene, and
a content ratio of the copolymerizable monomer in the monomer is not less than 35 mass %.

7. A structure for reinforcing a resin molded product in which a reinforcing sheet for a resin molded product is stuck to a resin molded product, and then heated to a temperature of not less than 80° C. to be brought into tight adhesive contact with the resin molded product to reinforce the resin molded product, wherein
the reinforcing sheet for a resin molded product includes a constraining layer, and a reinforcing layer laminated on the constraining layer,
the reinforcing layer is formed of an adhesive composition containing a polymer and a tackifier, and
the tackifier contains a high-softening-point tackifier having a softening point of not less than 120° C.

8. A structure for reinforcing a resin molded product according to claim 7, wherein the reinforcing sheet for a resin molded product is heated in advance to a temperature of not less than 80° C. and then stuck to the resin molded product.

9. A method for reinforcing a resin molded product, comprising the steps of:
sticking a reinforcing sheet for a resin molded product to a resin molded product; and
heating the reinforcing sheet for a resin molded product and/or the resin molded product to a temperature of not less than 80° C. to bring the reinforcing sheet for a resin molded product into tight adhesive contact with the resin molded product and thereby reinforce the resin molded product, wherein
the reinforcing sheet for a resin molded product includes a constraining layer, and a reinforcing layer laminated on the constraining layer,
the reinforcing layer is formed of an adhesive composition containing a polymer and a tackifier, and
the tackifier contains a high-softening-point tackifier having a softening point of not less than 120° C.

10. A method for reinforcing a resin molded product according to claim 9, wherein, in the step of sticking the reinforcing sheet for a resin molded product to the resin molded product, the reinforcing sheet for a resin molded product is heated in advance to a temperature of not less than 80° C. and then stuck to the resin molded product.

11. A structure for reinforcing a resin molded product in which a reinforcing sheet for a resin molded product is stuck to a resin molded product, and then heated to a temperature of not less than 80° C. to be brought into tight adhesive contact with the resin molded product to reinforce the resin molded product, wherein
the reinforcing sheet for a resin molded product includes a constraining layer, and a reinforcing layer laminated on the constraining layer,
the reinforcing layer is formed of an adhesive composition containing a polymer,
the polymer contains a hydrogenated product of a polymer of a monomer containing a conjugated diene and a copolymerizable monomer which can be copolymerized with the conjugated diene, and
a content ratio of the copolymerizable monomer in the monomer is not less than 35 mass %.

12. A structure for reinforcing a resin molded product according to claim 11, wherein the reinforcing sheet for a resin molded product is heated in advance to a temperature of not less than 80° C. and then stuck to the resin molded product.

13. A method for reinforcing a resin molded product, comprising the steps of:
sticking a reinforcing sheet for a resin molded product to a resin molded product; and
heating the reinforcing sheet for a resin molded product and/or the resin molded product to a temperature of not less than 80° C. to bring the reinforcing sheet for a resin molded product into tight adhesive contact with the resin molded product and thereby reinforce the resin molded product, wherein
the reinforcing sheet for a resin molded product includes a constraining layer, and a reinforcing layer laminated on the constraining layer,
the reinforcing layer is formed of an adhesive composition containing a polymer,
the polymer contains a hydrogenated product of a polymer of a monomer containing a conjugated diene and a copolymerizable monomer which can be copolymerized with the conjugated diene, and
a content ratio of the copolymerizable monomer in the monomer is not less than 35 mass %.

14. A method for reinforcing a resin molded product according to claim 13, wherein, in the step of sticking the reinforcing sheet for a resin molded product to the resin molded product, the reinforcing sheet for a resin molded product is heated in advance to a temperature of not less than 80° C. and then stuck to the resin molded product.
